(19) United States
(12) Patent Application Publication
(10) Pub. No.: US 2021/0088810 A1
(43) Pub. Date: Mar. 25, 2021

(54) SMART GLASSES

(71) Applicant: DRAGON SUMMIT GROUP INC., Grand Cayman (GB)

(72) Inventors: William Adams, Los Angeles, CA (US); Yu Ai, Beijing (CN); Jaren Goh Chee Wei, Singapore (SG)

(21) Appl. No.: 16/777,256

(22) Filed: Jan. 30, 2020

(30) Foreign Application Priority Data
Sep. 24, 2019 (CN) 201921595307.5

(51) Int. Cl. G02C 11/00; G02C 5/14; G01P 15/00; G01S 13/08; G06F 3/0488

(52) U.S. Cl. CPC G02C 11/10; G02C 5/146; G02C 2200/08; G01S 13/08; G06F 3/04883; G01P 15/00

(57) ABSTRACT

The embodiments described herein are related to a pair of smart glasses that include a pair of rims, a pair of lenses, a pair of arms, and a pair of connecting mechanisms. each of the lenses is framed by a corresponding one of the rims. Each of the connecting mechanism is configured to detachably connect each of the rims and a corresponding one of the arms. The smart glasses may also include a smart system embedded in at least one of the arms. The smart system may include a lithium battery, a Bluetooth interface, a loudspeaker, an audio module, a microcontroller, and a computer-readable memory.

### CROSS-REFERENCES TO RELATED APPLICATIONS

The present application claims priority to commonly owned CN application number 201921595307.5, filed on Sep. 24, 2019. The entire contents of the aforementioned application is incorporated herein by reference.

### TECHNICAL FIELD

The invention relates to smart devices. In particular, the invention relates to wearable smart glasses embedded therein a computing system (hereinafter also referred to as a smart system).

### BACKGROUND

A smart device is an electronic device, that may be connected to other devices or networks via different wireless protocols. Smart devices, such as smart glasses, can be designed to support a variety of form factors and a range of properties pertaining to ubiquitous computing. Smart glasses can be used in the physical world, human-centered environments and/or distributed computing environments.

For example, some smart glasses may add information in addition to what the wearer sees. Alternatively, or in addition, some smart glasses are able to change their optical properties at runtime. For example, some smart glasses are programmed to change tint by electronic means.

The existing smart system embedded in smart glasses often includes a power button, such that a user can turn the smart system on or off by pressing the power button. Many existing smart glasses often have their rims and legs bolted together, such that the smart system is permanently installed in the frame of the glasses, and not able to be replaced or removed easily. As such, it may be difficult to update or upgrade such smart systems, and when any part of the glasses is broken, the whole pair of glasses, including the computing system, must often be replaced.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to a pair of smart glasses. The smart glasses include a pair of rims, a pair of lenses, a pair of arms, and a pair of connecting mechanisms. Each of the lenses is framed by a corresponding one of the rims. Each of the connecting mechanisms is configured to detachably connect each of the rims and a corresponding one of the arms.

In particular, each connecting mechanism includes a first connecting part and a second connecting part. Each first connecting part is configured to be fixed at a rear end of the corresponding rim, and each second connecting part is configured to be fixed at a front end of the corresponding arm. The front end is an end that is closer to the lenses, and the rear end is an end that is further from the lenses. Each first connecting part and the corresponding second connecting part are configured to be detachably connected to each other.

In some embodiments, the rear end of each first connecting part includes a slot, and the front end of each second connecting part includes a protruding tab. The protruding tab is configured to slide into the slot. The interior surface of each slot may further include one or more elastic pieces, such that when each protruding tab is inserted into the corresponding slot, both the slots and protruding tabs are protected and tightly connected via the elastic pieces.

In some embodiments, the front end of each first connecting part may further include one or more connecting rods, and an outer edge of each rim includes a receptacle. Each connecting rod is configured to be inserted into the receptacle of the corresponding rim, such that each first connecting part is fixedly attached onto the corresponding rim. In some embodiments, the front end of each second connecting part may further include a fixing part. Each fixing part is fixedly attached onto the corresponding arm. Each fixing part includes a rotating pin that is rotatably connected to the corresponding protruding tab. As such, when each protruding tab slides into the corresponding slot of the first connecting part, the corresponding arm is capable of rotating about the rotating pin to open or close.

Furthermore, the smart glasses may also include a smart system that is embedded in at least one of the arms. The smart system (such as a computing system) includes a lithium battery, a Bluetooth interface, a loudspeaker, an audio module, a microcontroller, and a computer-readable memory. The audio module is configured to adjust a volume of the loudspeaker. The microcontroller is configured to connect electrically to the lithium battery, Bluetooth interface, and the audio module. The computer-readable memory stores computer-executable instructions. When the computer-executable instructions are executed by the microcontroller, the smart system is configured to cause the Bluetooth interface to wirelessly connect to a mobile terminal, and also configured to control the loudspeaker via the audio module.

In some embodiments, the smart system may also include a proximity sensor that is configured to detect whether the smart glasses are being worn by a user. The proximity sensor is electrically connected to the microcontroller. When the proximity sensor detects a nearby object, the microcontroller may set the smart system to a worn state. In the worn state, the smart system is powered on, and the Bluetooth interface is caused to be connected wirelessly to the mobile terminal. On the other hand, when the proximity sensor detects the absence of any nearby object, the microcontroller may set the smart system to a non-worn state. In the non-worn state, the smart system may be powered off, and/or the Bluetooth interface may be caused to be disconnected from the mobile terminal.

The proximity sensor may include a signal generator and a signal receiver. The signal generator emits a signal. A portion of the emitted signal may be reflected by a nearby object. The signal receiver is configured to detect the portion of the reflected signal. In response to a detection that a strength of the portion of the reflected signal is greater than a predetermined threshold, the microcontroller may set the smart system to the worn state. In response to a detection that the strength of the reflection signal is not greater than the predetermined threshold, the microcontroller may set the smart system to the non-worn state. In particular, the signal emitter and the signal receiver may be configured to emit and receive various signals, including, but are not limited to, (1) a light signal, (2) an infrared signal, (3) a radio-frequency electromagnetic signal, and/or (4) a sound signal.

Additionally, in some embodiments, at least one of the arms includes a USBC interface and/or a pin interface (e.g., a Pogo pin interface). In some embodiments, the microcontroller is configured to transmit data from or to another device via the USBC interface or the pin interface. Alternatively, or in addition, the USBC interface or the pin interface may be configured to charge the lithium battery.

In some embodiments, the smart system may further include a microphone that is electrically connected to the microcontroller. When the smart system is in the worn state, the microcontroller may be configured to receive a voice input from the microphone. Alternatively, or in addition, the smart system may also include a capacitive touch sensor configured to receive one or more touch gestures from a user. Each of the one or more touch gestures may be configured to cause the smart system to perform a particular function. For example, the one or more touch gestures may include (1) a single touch gesture, (2) a double touch gesture, (3) a triple touch gesture, and/or (4) press and hold gesture.

In some embodiments, the smart system may further include an accelerometer that is also electrically connected to the microcontroller. The accelerometer may be configured to detect an orientation of the smart glasses. Regardless of whether the proximity sensor detects a nearby object, when the accelerometer detects that the smart glasses are not properly oriented, the microcontroller may set the smart system into the non-worn state. On the other hand, only when the accelerometer detects that the smart glasses are properly oriented, and the proximity sensor detects a nearby object, the microcontroller may set the smart system into the worn state.

As such, the smart glasses disclosed herein allow users to easily detach and/or attach the arms from and/or to the rims of the glasses. Since the smart system is embedded in the arms, the detached smart system may be updated or upgraded as its user desires. Further, the various sensors embedded in the smart system automatically detect whether the smart glasses are being worn or not worn by a user. When the smart glasses are not worn by the user, the smart system may be powered off automatically, such that the battery life of the smart system may be extended. When the smart glasses are being worn by the user, the smart system may be turned on automatically to improve the user experience.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1A illustrates an example embodiment of smart glasses that implement the principles described herein;

FIG. 1B illustrates an example embodiment of smart glasses, in which one of the arms is detached from the rim;

FIG. 2A illustrates an example embodiment of an arm and a second connecting part of the smart glasses;

FIG. 2B illustrates an example embodiment of the smart glasses, in which one of the arms is detached from the corresponding rim of the smart glasses;

FIG. 3A illustrates an example architecture of a smart system that is embedded in the arms of the smart glasses;

FIG. 3B illustrates an example embodiment of a smart system that is embedded in the arms of the smart glasses;

FIG. 4 illustrates an example embodiment of a proximity sensor that may be implemented in the smart system of the smart glasses;

FIG. 5 illustrates a flowchart of an example method for automatically activating or deactivating the smart system of the smart glasses; and

FIG. 6 illustrates an example computing system in which the smart system embedded in the smart glasses described herein may be employed.

### DETAILED DESCRIPTION

The embodiments described herein are related to a pair of smart glasses. The smart glasses include a pair of rims, a pair of lenses, a pair of arms, and a pair of connecting mechanisms. Each of the lenses is framed by a corresponding rim of the rims. Each of the connecting mechanisms is configured to detachably connect each of the rims with a corresponding one of the arms.

Furthermore, the smart glasses may also include a smart system that is embedded in at least one of the arms. The smart system (such as a computing system) may include one or more components including, but are not limited to: a lithium battery, a Bluetooth interface, a loudspeaker, an audio module, a microcontroller, a computer-readable memory, a proximity sensor, a USBC interface and/or a pin interface, a microphone, and/or an accelerometer.

As such, the smart glasses disclosed herein allow users to easily detach and/or attach the arms from and/or to the rims of the glasses. Since the smart system is embedded in the arms, the detached smart system may be updated or upgraded as its user desires. Further, the various sensors embedded in the smart system automatically detect whether the smart glasses are being worn or not worn by a user. When the smart glasses are not worn by the user, the smart system may be powered off automatically, such that the battery life of the smart system may be extended. When the smart glasses are being worn by the user, the smart system may be turned on automatically to improve the user experience.

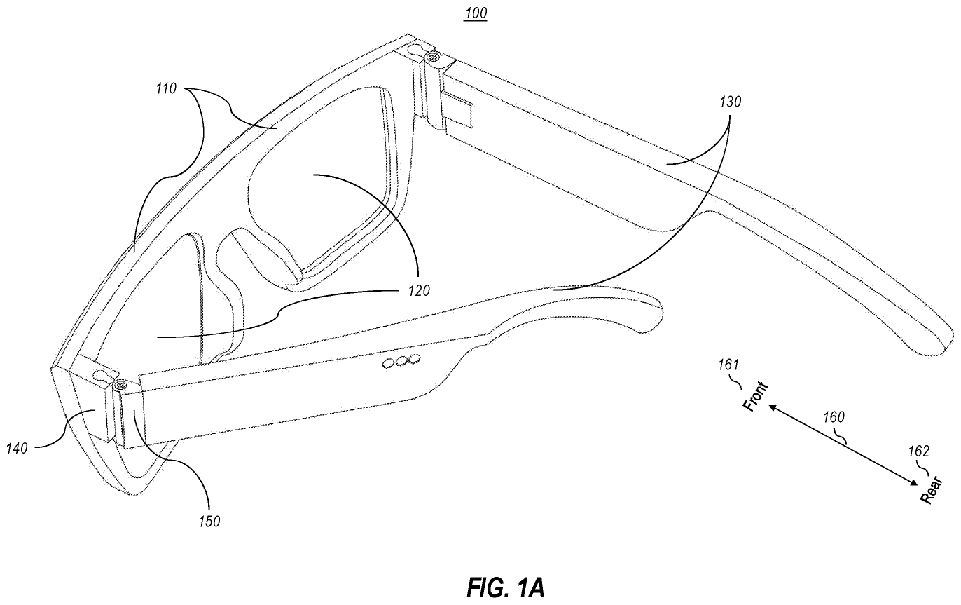

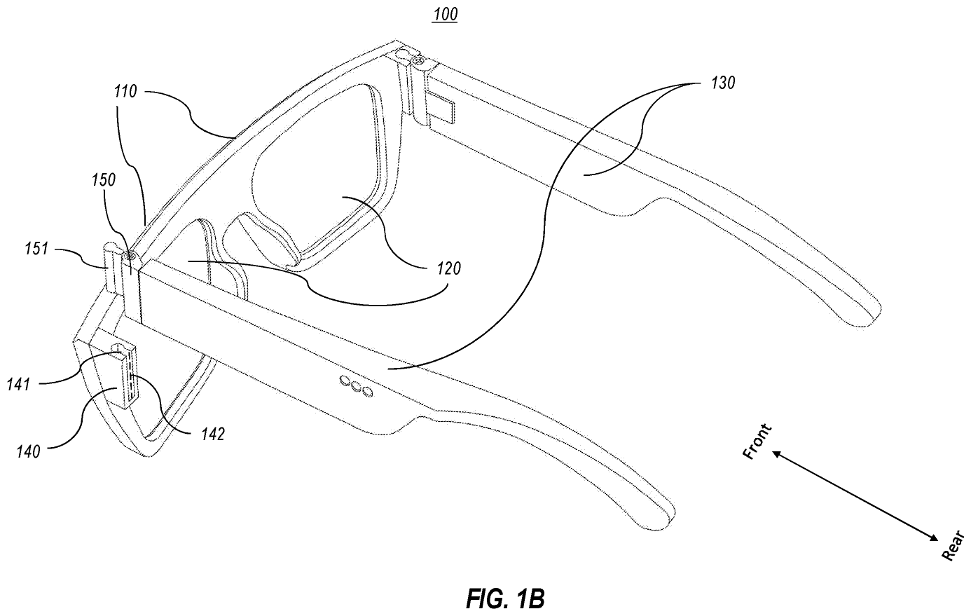

FIGS. 1A and 1B illustrate an example embodiment of the smart glasses 100 that implement the principles described herein. As illustrated in FIG. 1A, the smart glasses 100 includes a pair of rims 110, a pair of lenses 120, and a pair of arms 130. Each of the lenses 120 is framed by a corresponding rim 110. The smart glasses 100 further includes a pair of connecting mechanisms 4, 5, each of which is configured to detachably connect one of the rims 110 and a corresponding arm 130.

In particular, each connecting mechanism 140, 150 includes a first connecting part 140 and a second connecting part 150. Each first connecting part 140 is configured to be fixed at a rear end of the corresponding rim 110, and each second connecting part 150 is configured to be fixed at a front end of the corresponding arm 130. The front end is an end that is close to the lenses, and the rear end is an end that is further from the lenses. The direction of the front 161 and the back 162 are represented by the bi-directional arrow 160. Importantly, each first connecting part 140 and the corresponding second connecting part 150 are configured to be detachably connected to each other.

FIG. 1B illustrates an example embodiment of the smart glasses, in which one of the first connecting part 140 and the corresponding second connecting part 150 are detached from each other. As illustrated in FIG. 1B, the first connecting part 140 includes a slot 141, and the second connecting part 150 includes a protruding tab 151. Each protruding tab 151 is configured to slide into the corresponding slot 141. As such, when the protruding tab 151 slides into the corresponding slot 141, the arm 130 and the rim 110 are connected; and when the protruding tab 151 slides out of the corresponding slot 141, the arm 130 and the rim 110 are detached from each other, such that each rim 110 and the corresponding arm 130 are detachably connected to each other via the connecting mechanism 140, 150. In some embodiments, the interior surface of each slot 141 may further include one or more elastic pieces 142, such that when each protruding tab 151 is inserted into the corresponding slot 141, both the slots 6 and protruding tabs 151 are protected and tightly connected via the elastic pieces 142.

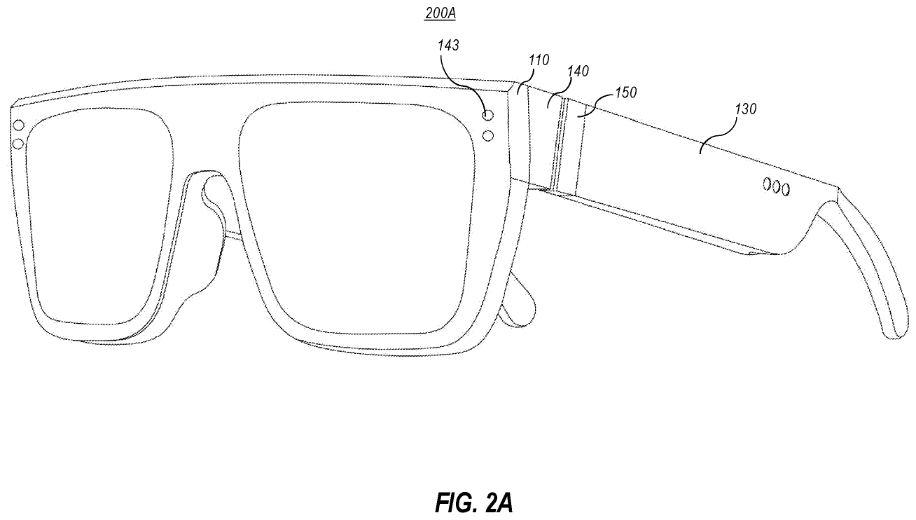

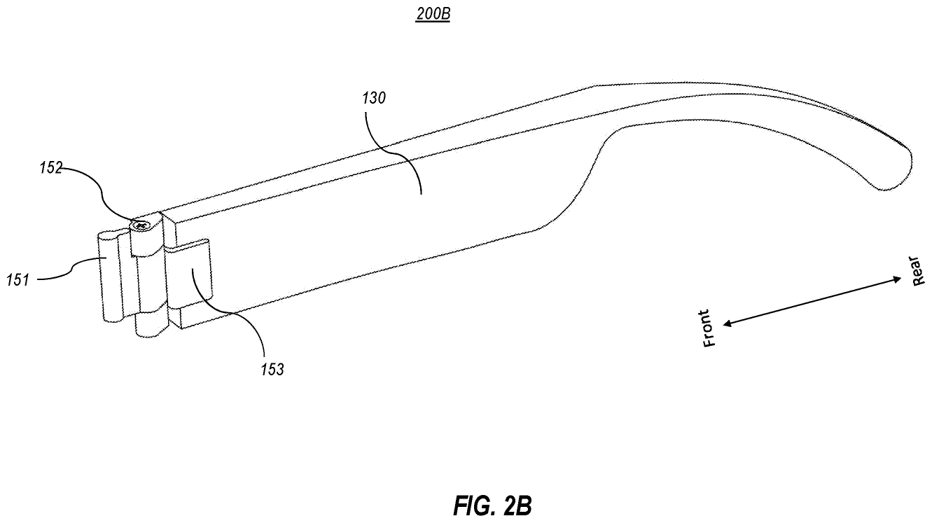

FIG. 2A illustrates further illustrates an example embodiment 200A of the first connecting part 140. As illustrated in FIG. 2A, the front end of each first connecting part 140 may include one or more connecting rods 143, and an outer edge of each rim 110 may include a receptacle. Each connecting rod 143 is configured to be inserted into the receptacle of the corresponding rim 110, such that each first connecting part 140 is fixedly attached onto the corresponding rim 110.

FIG. 2B further illustrates an example embodiment 200B of the arm 130 and the second connecting part 150 of the smart glasses 100. As illustrated in FIG. 2A, the front end of each second connecting part 150 may include a fixing part 153. Each fixing part 153 may be fixedly attached onto the corresponding arm 130. Each fixing part 153 may further include a rotating pin 152 that is rotatably connected to the corresponding protruding tab 151. As such, when each protruding tab 151 slides into the corresponding slot 141 of the first connecting part 140, the corresponding arm 130 can rotate about the rotating pin 152 to open and close.

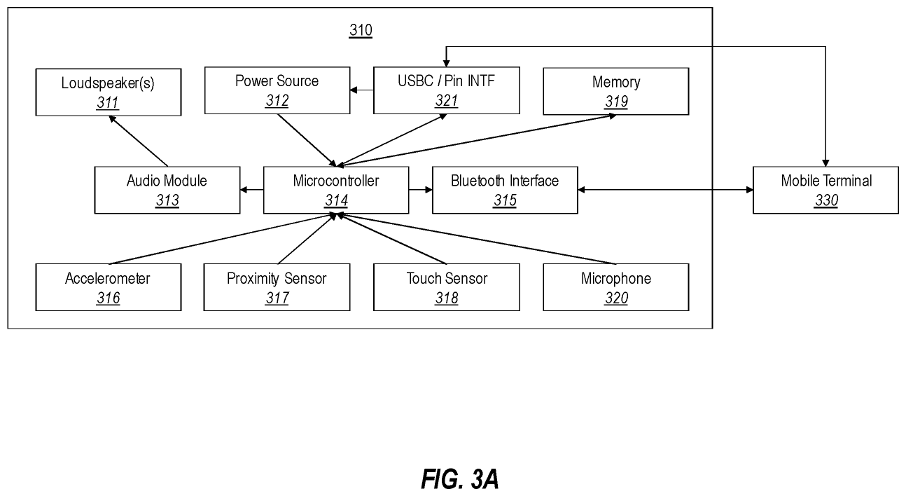

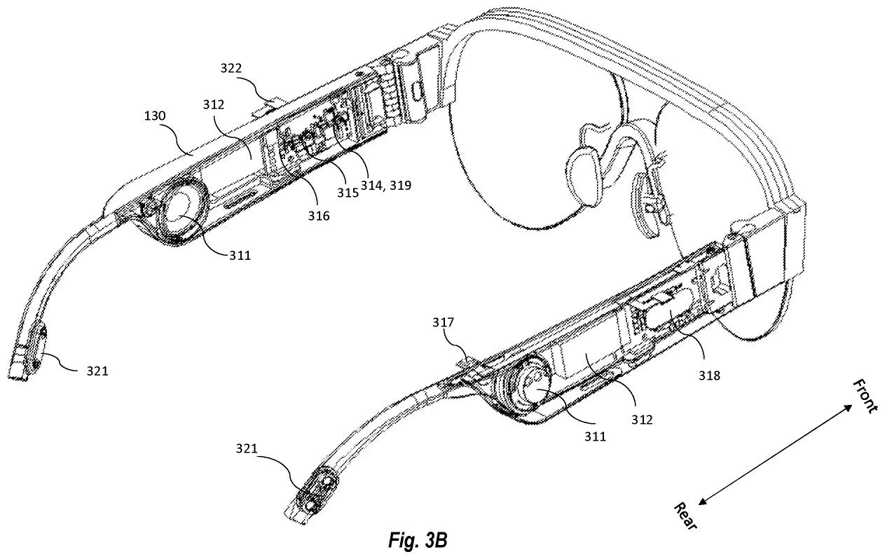

Further, the smart glasses 100 may include a smart system that is embedded in at least one of the arms 3. FIG. 3A illustrates an example architecture of the smart system 310. The smart system 310 includes a power source 312 (e.g., a lithium battery), a Bluetooth interface 315, one or more loudspeaker(s) 311, an audio module 313, and a computer-readable memory 319. The audio module 313 is configured to adjust the volume of the loudspeaker. The audio module 313 may include a software component that adjust the input signal of the loudspeaker 311. Alternatively, or in addition, the audio module 313 may also include a hardware component that adjust the voltage of the loudspeaker 311 to adjust the gain of the loudspeaker 311.

The microcontroller 314 is configured to connect electrically to the power source 312, the Bluetooth interface 315, and the audio module 313. The computer-readable memory 319 stores computer-executable instructions. When the computer-executable instructions are executed by the microcontroller 314, the smart system 310 is configured to cause the Bluetooth interface 315 to wirelessly connect to a mobile terminal 330, and also configured to control the loudspeaker(s) 311 via the audio module 313. The mobile terminal 330 may be a mobile device (e.g., a mobile phone). When the smart system 310 is connected to the mobile terminal 330, the smart system 310 may be used to control the mobile terminal 330; alternatively, or in addition, the mobile terminal 330 may also be used to control the smart system 310.

In some embodiments, the smart system 310 may also include a proximity sensor 317 that is configured to detect whether the smart glasses 100 are being worn by a user. The proximity sensor 317 is also electrically connected to the microcontroller 314. When the proximity sensor 317 detects a nearby object, the microcontroller 314 may set the smart system 310 to a “worn state”. In the worn state, the smart system 310 is powered on, and the Bluetooth interface 315 may be caused to wirelessly connect to the mobile terminal 330. On the other hand, when the proximity sensor 317 does not detect any nearby object, the microcontroller 314 may set the smart system 310 to a “non-worn state”. In the non-worn state, the smart system 310 may be powered off, and the Bluetooth interface 315 may be caused to be disconnected from the mobile terminal.

Additionally, in some embodiments, at least one of the arms includes a USBC interface and/or a pin interface (e.g., a Pogo pin interface) 321. In some embodiments, the microcontroller 314 is configured to transmit data from or to another device (e.g., the mobile terminal 330) via the USBC interface or the pin interface 321. Alternatively, or in addition, the USBC interface or the pin interface may be configured to charge the power source 312 (e.g., lithium battery).

In some embodiments, the smart system 310 may further include a microphone 320 that is also electrically connected to the microcontroller 314. When the smart system 310 is in the worn state, the microcontroller 314 is configured to receive a voice input from the microphone 320. Alternatively, or in addition, the smart system 310 may also include a capacitive touch sensor 318 configured to receive one or more touch gestures from a user. Each of the one or more touch gestures may be configured to cause the smart system 310 to perform a particular function. For example, the one or more touch commands may include (1) a single touch gesture, (2) a double touch gesture, (3) a triple touch gesture, and/or (4) press and hold gesture.

In some embodiments, the smart system 310 may further include an accelerometer 316 that is also electrically connected to the microcontroller 314. The accelerometer 316 may be configured to detect an orientation of the smart glasses 100. Regardless of whether the proximity sensor 317 detects a nearby object, when the accelerometer 316 detects that the smart glasses 100 are not properly oriented, the microcontroller 314 may set the smart system 310 into the non-worn state. On the other hand, only when the accelerometer 316 detects that the smart glasses 100 are properly oriented, and the proximity sensor 317 detects a nearby object, the microcontroller 314 may set the smart system into the worn state.

In at least one embodiment, the worn state or the non-worn state may also be customized by the user. For example, the user may set that in non-worn state, the smart system may turn off the speaker, but the microphone and proximity sensor may still be left on. As another example, the user may set that when the smart system is in non-worn state for a predetermined period, the smart system is completely powered off, and a user must press a physical button to turn the smart system on again.

FIG. 3B illustrates an example structural implementation of the smart system 310 that is embedded in the arms 130 of the smart glasses 100. Some of the components 311-321 may be embedded in one of the arms 130 or in both of the arms 3. As illustrated in FIG. 3B, the microcontroller 314, the Bluetooth interface 315, and the accelerometer 316 are placed in a front area of the arm 130. The loudspeakers 311 are placed in the middle rear side of each arm 130, such that when a user wears the smart glasses 100, the speakers 311 are next to the user's ears. The USBC or pin interface 309 may be placed at the rear end of the arm 130. In some embodiments, the smart system 310 may use a flat printed circuit cable 322 to connect the various components 311-321.

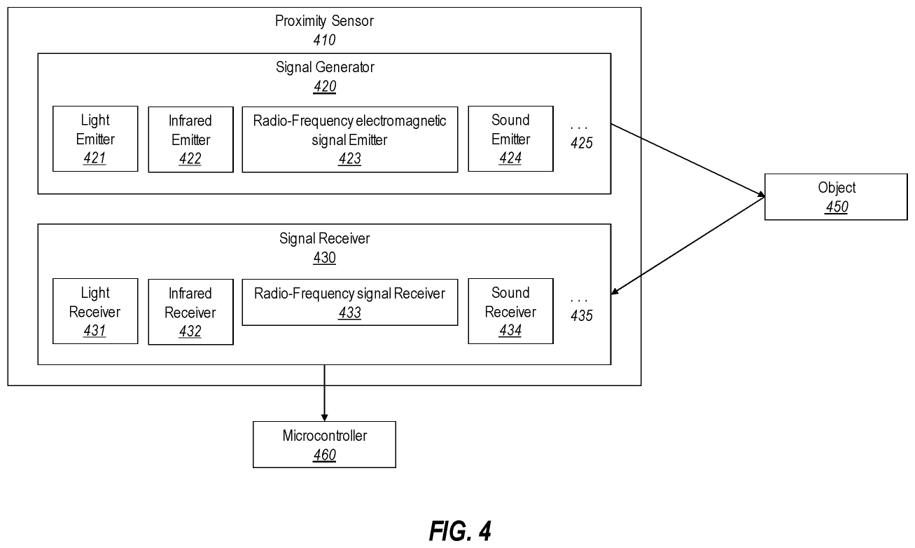

FIG. 4 illustrates an example embodiment of a proximity sensor 410, which may correspond to the proximity sensor 317 of FIGS. 3A and 3B. The proximity sensor 410 may include a signal generator 420 and a signal receiver 430. The signal generator 420 emits a signal. A portion of the emitted signal may be reflected by a nearby object 450 (e.g., human body or skin). The signal receiver 430 is configured to detect the portion of the reflected signal. The signal receiver 430 may send the detection result to the microcontroller 460, which may correspond to the microcontroller 314 of FIGS. 3A and 3B. In response to a detection that a strength of the portion of the reflected signal is greater than a predetermined threshold, the microcontroller 460 may set the smart system to the worn state. On the other hand, in response to a detection that the strength of the reflection signal is not greater than the predetermined threshold, the microcontroller may send the smart system to the non-worn state.

Various signal generators 420 and/or signal receivers 430 may be implemented. For example, the signal generator 420 may include an electromagnetic signal emitter 421-423. Various frequency bands of electromagnetic signal emitter may be generated. For example, the signal generator 420 may be a light emitter 421, an infrared emitter 422, and/or a radio-frequency electromagnetic signal emitter 423. In some embodiments, the signal generator may also be a sound emitter 424 (e.g., ultrasound emitter). The signal receiver 430 accompanying the signal generator 420 would be configured to detect a corresponding signal generated by the signal generator 420. For example, a light receiver 431, an infrared receiver 432, a radio-frequency electromagnetic signal receiver 433, and/or a sound receiver 434 may be implemented as the signal receiver 430. The ellipsis 425 and 435 represent that there may be additional or any number of signal generators and receivers implemented in the proximity sensor 410.

The following discussion now refers to a method and method acts that may be performed. Although the method acts may be discussed in a certain order or illustrated in a flow chart as occurring in a particular order, no particular ordering is required unless specifically stated, or required because an act is dependent on another act being completed prior to the act being performed.

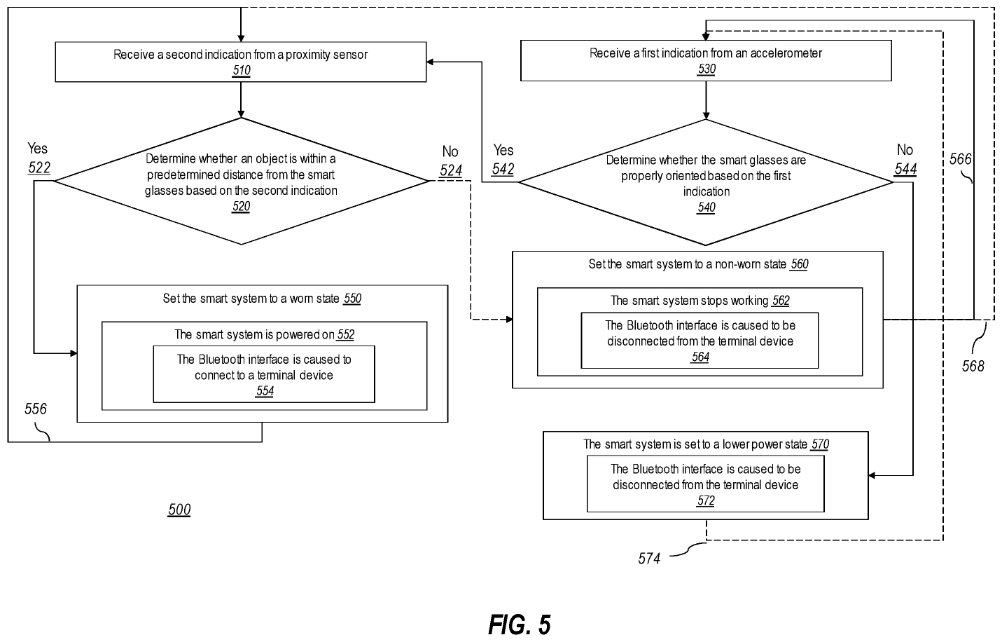

FIG. 5 illustrates a flowchart of an example method 500 for activating and deactivating a smart system embedded in smart glasses. The smart system may correspond to the smart system 310 of FIG. 3A. The method 500 includes receiving a first indication from an accelerometer (530) and determining whether the smart glasses are properly oriented based on the first indication (540). When it is determined that the smart glasses are not properly oriented (544) based on the indication from the accelerometer (530), the smart system may be set to a low power state (570). In some embodiments, when the smart system is in the low power state, the smart system will cause the Bluetooth connection with the mobile device to be cut off until the accelerometer detects the smart system is properly oriented. On the other hand, when it is determined that the smart glasses are properly oriented, the system then goes to the proximity sensor (542). The smart system receives a second indication from the proximity sensor (510). Based on the indication received from the proximity sensor (510), the system then determines whether an object is within a predetermined distance from the smart glasses (520). The proximity sensor may correspond to the proximity sensor 410 of FIG. 4.

In response to a determination that the object is within a predetermined distance (522) in addition to the determination that the smart glasses are properly oriented (542), the smart system is set to a worn state (520). The setting the smart system to a worn state 550 may include powering on the smart system (552) and/or causing a Bluetooth interface to be connected to a terminal device (554).

Alternatively, in response to a determination that the object is not within a predetermined distance (523), the smart system may be set to a non-worn state (560). The setting the smart system to a non-worn state (560) may include stopping the current process, such as pausing the music player, powering off the smart system (562), causing the Bluetooth interface to be disconnected from the terminal device (564), and/or keeping the smart system in the non-worn state until time out.

The arrows 556, 566, 568, and 574 represent that the proximity sensor and/or the accelerometer may be constantly detecting and receiving signals regarding whether the smart glasses are properly oriented and whether an object is nearby. The detecting may be performed at a predetermined frequency (e.g., once per minute, once per second, etc.), such that when the status of the smart glasses changes, the microcontroller may update the state of the smart system between the worn state and the non-worn state.

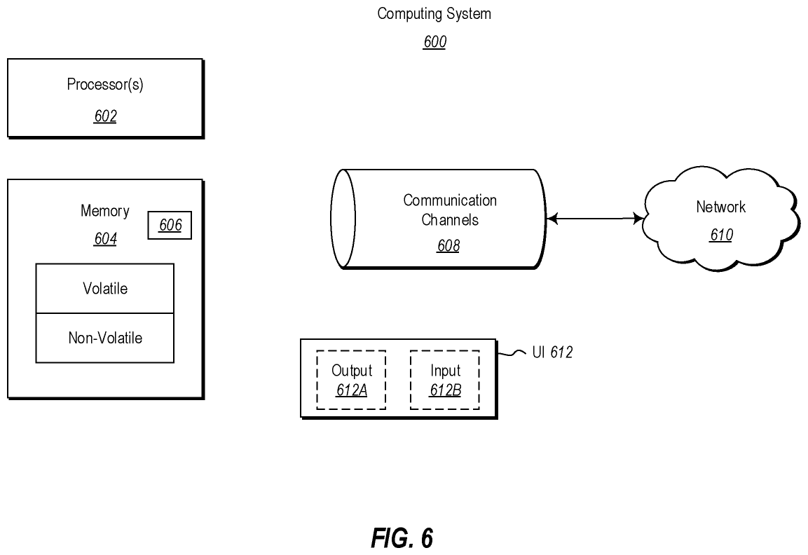

Finally, because the principles described herein may be performed in the context of a computing system (for example, each of the smart system 310 and/or the mobile terminal 330 may include one or more computing systems) some introductory discussion of a computing system will be described with respect to FIG. 6.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 6, in its most basic configuration, a computing system 600 typically includes at least one hardware processing unit 602 and memory 604. The processing unit 602 may include a general-purpose processor and may also include a field-programmable gate array (FPGA), an application-specific integrated circuit (ASIC), or any other specialized circuit. The memory 604 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 600 also has thereon multiple structures often referred to as an “executable component”. For instance, memory 604 of the computing system 600 is illustrated as including executable component 606. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 604 of the computing system 600. Computing system 600 may also contain communication channels 608 that allow the computing system 600 to communicate with other computing systems over, for example, network 610.

While not all computing systems require a user interface, in some embodiments, the computing system 600 includes a user interface system 612 for use in interfacing with a user. The user interface system 612 may include output mechanisms 612A as well as input mechanisms 612B. The principles described herein are not limited to the precise output mechanisms 612A or input mechanisms 612B as such will depend on the nature of the device. However, output mechanisms 612A might include, for instance, speakers, displays, tactile output, holograms and so forth. Examples of input mechanisms 612B might include, for instance, microphones, touchscreens, holograms, cameras, keyboards, mouse or other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing system which may correspond to the computing system 600 previously described. The computing systems of the remaining figures include various components or functional blocks that may implement the various embodiments disclosed herein as will be explained. The various components or functional blocks may be implemented on a local computing system or may be implemented on a distributed computing system that includes elements resident in the cloud or that implement aspect of cloud computing. The various components or functional blocks may be implemented as software, hardware, or a combination of software and hardware. The computing systems of the remaining figures may include more or less than the components illustrated in the figures and some of the components may be combined as circumstances warrant. Although not necessarily illustrated, the various components of the computing systems may access and/or utilize a processor and memory, such as processor 602 and memory 604, as needed to perform their various functions.

As mentioned above, each of the smart system 310 and/or the mobile terminal 330 may include one or more computing systems. As such, the principles described herein are implemented in an environment including one or more computing systems that are configured to communicate with each other directly or indirectly via computer networks. In particular, the principles described herein allow the users to detach the smart system from the rims and lenses of the glasses, such that the smart system may be updated or upgraded as the users desire. Further, the various sensors implemented in the smart system allow the smart system to be set automatically in a worn state or non-worn state, which improves the user's experience and also reduces the power consumption.

For the processes and methods disclosed herein, the operations performed in the processes and methods may be implemented in differing order. Furthermore, the outlined operations are only provided as examples, an some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A pair of smart glasses, comprising
a pair of rims;
a pair of lenses, each of the lenses being framed by a corresponding one of the rims;
a pair of arms; and
a pair of connecting mechanisms configured to detachably connect each of the rims with a corresponding one of the arms, each connecting mechanism comprising:
a first connecting part and
a second connecting part, wherein:
the first connecting part is configured to be fixed at a rear end of the corresponding one of the rims,
the second connecting part is configured to be fixed at a front end of the corresponding one of the arms, the front end being an end that is closer to the lenses, and the rear end being an end that is further from the lenses; and
the first connecting part and the second connecting part are configured to be detachably connected to each other.

2. The smart glasses according to claim 1, wherein:
the rear end of the first connecting part comprises a slot;
the front end of the second connecting part comprises a protruding tab; and
the protruding tab is configured to slide into the slot.

3. The smart glasses according to claim 2, wherein an interior surface of the slot comprises one or more elastic pieces, such that when the protruding tab is inserted into the slot, both the slot and the protruding tab are protected and tightly connected via the one or more elastic pieces.

4. The smart glasses according to claim 2, wherein:
a front end of the first connecting part comprise one or more connecting rods;
an outer edge of at least one rim selected from the pair of rims comprises a receptacle; and
the one or more connecting rods are configured to be inserted into the receptacle of the at least one rim, such that the first connecting part is fixedly attached onto the at least one rim.

5. The smart glasses according to claim 4, wherein:
the front end of each second connecting part comprising a fixing part;
the fixing part is fixedly attached onto an arm selected from the pair of arms; and
the fixing part comprises a rotating pin that is rotatably connected to the protruding tab, such that when the protruding tab slides into the slot of the first connecting part, the arm is configured to rotate about the rotating pin to open and close.

6. The smart glasses according to claim 1, further comprising a smart system that is embedded in at least one of the arms, the smart system comprising:
a lithium battery,
a Bluetooth interface;
a loudspeaker;
an audio module configured to adjust a volume of the loudspeaker;
a microcontroller configured to connect electrically to the lithium battery, the Bluetooth interface, and the audio module; and
a computer-readable memory, stored thereon computer-executable instructions, when executed by the microcontroller, configure the smart system to perform the following:
cause the Bluetooth interface to wirelessly connect to a mobile terminal; and
control the loudspeaker via the audio module.

7. The smart glasses according to claim 6, the smart system further comprising a proximity sensor configured to detect whether the smart glasses are being worn by a user, wherein:
the proximity sensor is electrically connected to the microcontroller, and
when the proximity sensor detects a nearby object, the microcontroller sets the smart system to a worn state, in which the smart system is powered on, and the Bluetooth interface is caused to wirelessly connect to the mobile terminal.

8. The smart glasses according to claim 7, wherein when the proximity sensor detects an absence of the nearby object, the microcontroller sets the smart system to a non-worn state, in which the smart system is powered off, and the Bluetooth interface is caused to be disconnected from the mobile terminal.

9. The smart glasses according to claim 7, wherein:
the proximity sensor comprises a signal emitter and a signal receiver;
the signal emitter is configured to emit a signal, wherein when the signal is received by the nearby object, the nearby object reflects a portion of the received signal back to the proximity sensor;
the signal receiver is configured to detect the portion of the reflected signal;
in response to a detection that a strength of the portion of the reflected signal is greater than a predetermined threshold, the microcontroller sets the smart system to the worn state; and
in response to a detection that the strength of the reflected signal is not greater than the predetermined threshold, the microcontroller sets the smart system to a non-worn state.

10. The smart glasses according to claim 9, wherein:
the signal emitter is configured to emit a signal that includes at least one of (1) a light signal, (2) an infrared signal, (3) a radio-frequency electromagnetic signal, or (4) an ultrasound signal; and
the signal receiver is configured detect a corresponding type of signal that the signal emitter is configured to emit.

11. The smart glasses according to claim 7, the smart system further comprising:
a microphone that is electrically connected to the microcontroller, wherein when the smart system is in the worn state, the microcontroller is configured to receive a voice input from the microphone.

12. The smart glasses according to claim 7, wherein:
the smart system further comprises an accelerometer that is electrically connected to the microcontroller;
the accelerometer is configured to detect an orientation of the smart glasses; and
regardless of whether the proximity sensor detects a nearby object, in response to a detection that the smart glasses are not properly oriented, the microcontroller sets the smart system into a non-worn state.

13. The smart glasses according to claim 11, wherein:
in response to a determination that the smart glasses are properly oriented, and that a proximity sensor detects a nearby object, the microcontroller sets the smart system into a worn state.

14. The smart glasses according to claim 6, the at least one of the arms including at least one of a USBC interface or a pin interface.

15. The smart glasses according to claim 14, wherein the microcontroller is configured to transmit data from or to another device via the USBC interface or the pin interface.

16. The smart glasses according to claim 14, wherein the USBC interface or the pin interface is configured to charge the lithium battery.

17. The smart glasses according to claim 6, wherein the smart system further comprises a capacitive touch sensor configured to receive one or more touch gestures from a user, each of the one or more touch gestures is configured to cause the smart system to perform a particular function.

18. The smart glasses according to claim 17, wherein the one or more touch gestures comprise at least one of (1) a single touch gesture, (2) a double touch gesture, (3) a triple touch gesture, or (4) press and hold gesture.

19. A method implemented at a pair of smart glasses that comprises a smart system for automatically activating or deactivating the smart system, the smart system comprising a Bluetooth interface, a loudspeaker, a proximity sensor, and an accelerometer, the method comprising:
determining whether the smart glasses are properly oriented based on a first signal received from an accelerometer;
determining whether an object is within a predetermined distance from the pair of smart glasses based on a second signal received from a proximity sensor;
in response to determining that: (1) an object is positioned within the predetermined distance from the smart glasses, and (2) the smart glasses are properly oriented, setting the smart system to a worn state, in which the smart system is powered on, and the Bluetooth interface is configured to connect to a terminal device; and
in response to determining at least one of the following: (1) that no object is positioned within the predetermined distance from the smart glasses, or (2) that the smart glasses are not properly oriented, setting the smart system to a lower power state or a non-worn state.

20. A computer program product comprising one or more hardware storage devices having stored thereon computer-executable instructions that are structured such that, when executed by one or more processors of a pair of smart glasses, the computer-executable instructions cause the pair of smart glasses to perform the following:
receiving a first indication from an accelerometer;
determining whether the pair of smart glasses are properly oriented based on the first indication;
receiving a second indication from a proximity sensor;
determining whether an object is within a predetermined distance from the pair of smart glasses based on the second indication;
in response to determining that: (1) the object is positioned within the predetermined distance from the pair of smart glasses, and (2) the pair of smart glasses are properly oriented, setting the smart glasses to a worn state, in which the smart glasses is powered on, and a Bluetooth interface is caused to connect to a terminal device; and
in response to determining at least one of the following: (1) that no object is positioned within the predetermined distance from the pair of smart glasses, or (2) that the pair of smart glasses are not properly oriented, setting the smart glasses to a lower power state or a non-worn state.
